(19) United States
(12) Patent Application Publication
(10) Pub. No.: US 2014/0122344 A1
(43) Pub. Date: May 1, 2014

(54) Secure Computing Environment

(71) Applicant: BARCLAYS BANK PLC, London (GB)

(72) Inventors: Darren Foulds, Headley (GB); Steven Bradley, Knutsford (GB); Andrew Crichton, Knutsford (GB); George French, Northampton (GB); Arthur Leung, London (GB); Michael Naggar, Frisco, TX (US); Ashutosh Sureka, Frisco, TX (US)

(73) Assignee: BARCLAYS BANK PLC, London (GB)

(21) Appl. No.: 13/718,086

(22) Filed: Dec. 18, 2012

(30) Foreign Application Priority Data
Oct. 30, 2012 (GB) 1219515.2

(51) Int. Cl. G06Q 20/38

(52) U.S. Cl. CPC G06Q 20/38215
USPC 705/67; 705/65

(57) ABSTRACT

A portable electronic device having a memory storing application software for initiating a payment transaction with a remote system, a data interface for coupling the device to a host computer, a contactless interface for receiving payment token data from a contactless payment token, and a cellular network interface for communication of data over a cellular network. The application software is executed from the device when the device is connected to the host computer and configures the portable electronic device to initiate a payment transaction by receiving payment token data via the contactless interface means and transmitting said payment token data to the remote system via the mobile network interface means.

### FIELD OF THE INVENTION

This invention relates to secure data storage, access and communication, and more particularly to a system, device and method for providing access to online services in a secure computing environment.

### BACKGROUND OF THE INVENTION

Secure computing environments that store and run software applications from a portable electronic Universal Serial Bus (“USB”) flash memory device plugged into a host computer are generally known, such as IronKey, Imotion, Option CloudKey and Kobil mIDentity. Typically in such environments, secure authentication to the associated service and encryption is provided by the USB device itself. However, the USB flash memory devices in known environments rely at least in part on use of the host computer for processing and communication of data for a transaction. Therefore, known computing environments are susceptible to security breaches, for example, from malicious software or hardware resident on the host computer.

As such secure computing environments become more prevalent, there is a need for improved systems and techniques to provide enhanced protection and security of software application data and encryption key data that are stored in the protected memory of these devices.

### STATEMENTS OF THE INVENTION

According to one aspect of the present invention, there is provided a portable electronic device comprising memory storing application software for initiating a payment transaction with a remote system. The portable electronic device also includes a data interface for coupling the device to a host computer and a contactless interface for receiving payment token data from a contactless payment token. A cellular network interface is provided for communication of data over a cellular network. In use, the application software is executed from the portable electronic device when the portable electronic device is connected to the host computer and configures the portable electronic device to initiate a payment transaction by receiving payment token data via the contactless interface and transmitting the payment token data to the remote system via the mobile network interface.

Preferably, the application software further configures the portable electronic device to establish a secure connection with a remote mobile gateway over the cellular data network. Preferably, the data interface comprises a Universal Serial Bus (“USB”) data interface, the memory comprises a non-volatile flash memory, and the contactless payment token is a Near Field Communication (“NFC”) capable payment card or mobile device.

Preferably, the application software comprises a web browser for displaying an application interface including a web form for initiating the payment transaction. The application software further configures the portable electronic device to automatically populate the web form with the received payment token data.

According to another aspect of the present invention, there is provided a method for secure transaction processing in a portable electronic device. The portable electronic device includes a memory storing application software executable from the device, a data interface for coupling the device to a host computer, a contactless interface for receiving payment token data from a contactless payment token, and a cellular network interface for communication of data over a cellular network. The method comprises executing the stored application software from the portable electronic device when the portable electronic device is connected to the host computer to initiate a payment transaction with a remote system. The method further includes receiving payment token data via the contactless interface, and transmitting the payment token data to the remote system via the mobile network interface.

In a further aspect of the present invention, there are provided associated computer programs arranged to configure a system or device to become configured as the above portable electronic device or to carry out the above method.

### BRIEF DESCRIPTION OF THE DRAWINGS

There now follows, by way of example only, a detailed description of embodiments of the present invention, with references to the figures identified below.

FIG. 1 is a block diagram showing the main components of a secure computing environment;

FIG. 2 is a block diagram showing the main components of an electronic device in the secure computing environment of FIG. 1 according to an embodiment of the invention;

FIG. 3 is a flow diagram illustrating the main processing steps performed by components of the computing environment of FIG. 1 for an example of a device and user authorisation process;

FIG. 4 is a flow diagram illustrating the main processing steps performed by component of the computing environment of FIG. 1 according to a first embodiment; and

FIG. 5 is a flow diagram illustrating the main processing steps performed by component of the computing environment of FIG. 1 according to a second embodiment.

### DETAILED DESCRIPTION OF THE INVENTION

### Secure Computing Environment

Portable USB flash memory devices that store and run software applications completely within the device itself are a way of providing highly secure control and access to online services in a secure computing environment, without using the network connection of the host computer to which the USB device is connected. In an online banking environment, the USB flash memory device provides secure access to a user's financial account data and account services provided by an online banking backend system, via custom browser software securely stored on the device that is automatically loaded and executed when the USB flash memory device is connected to a host computer, to render the custom browser user interface (“UI”) for display to the user.

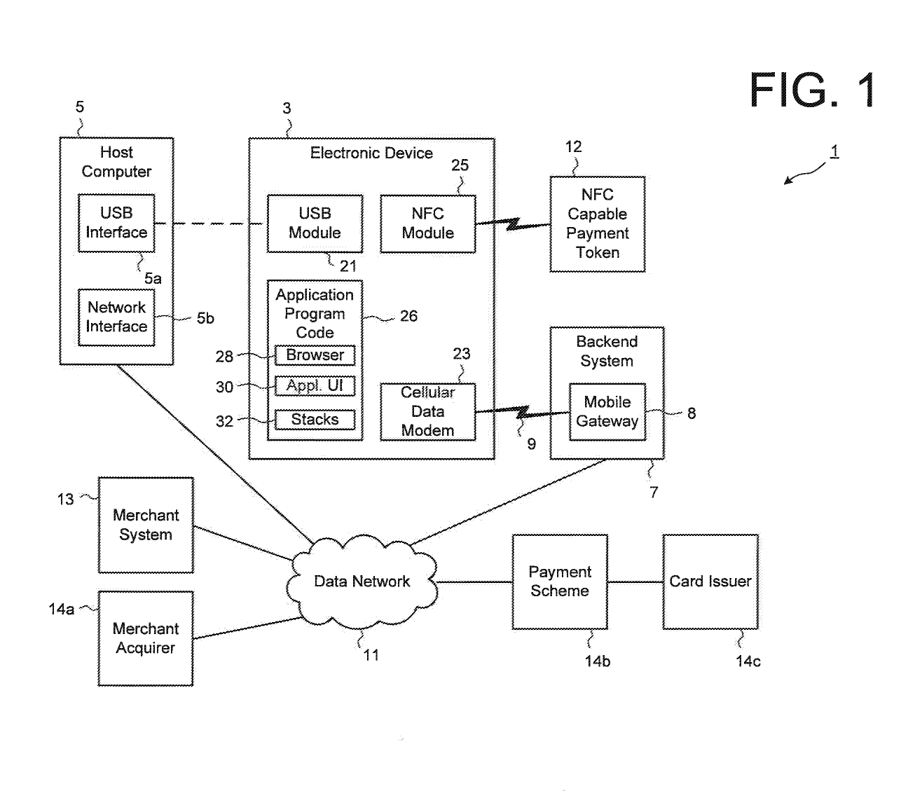

Referring to FIG. 1, a secure computing environment 1 is made up of a number of components: the portable USB flash memory device (referred to herein as the “electronic device”) 3, the host computer 5 and the backend system 7. The electronic device 3 is a secure and self-contained device with a USB serial communication module 21 for connecting the device to a USB interface 5a of the host computer 5. The electronic device 3 also includes an on-board cellular data modem 23 for secure network access to services provided by a backend system 7, via a direct and authenticated connection to a mobile gateway 8 of the backend system 7 over a cellular data network 9. The mobile gateway 8 may be a computer server providing APIs (Application Program Interfaces) to customer banking functionalities, such as looking up account balance, making payments, making transfers, etc.

The USB serial communication module 21 provides a link between custom browser software 28 and security and network stacks 32 on the electronic device 3, in order to translate and transmit HTTP/HTTPS requests from the custom browser 28 running on the electronic device 3 via the host computer 5 over the USB serial communication module 21 and the serial USB interface 5a, and to return the responses back to the browser application 28. Optionally, this USB serial communication module 21 can also include a set of interfaces that allow the custom browser 28 access to custom functions on the electronic device 1

The cellular data network 9 may be any suitable cellular data communication network such as GPRS (General Packet Radio Service), EDGE (Enhanced Data-rates for Global Evolution), 3G (third generation of mobile phone mobile communications standards), LTE (Long Term Evolution), or 4G (fourth generation of mobile phone mobile communications standards), for example. The host computer 5, which can be a personal computer, portable laptop, tablet PC, or the like, typically communicates data over a data network 11 via a communication network interface 5b. The host computer 5 may also include components included in commonly known computing devices, such as a processor, a display, user input devices and controllers, etc., which are not shown. The data network 11 may be any suitable data communication network such as a wireless network, a local- or wide-area network including a corporate intranet or the Internet, using for example the TCP/IP protocol. Such communication protocols are of a type that are known to those skilled in the art of data networks and need not be described further.

The USB device 3 also includes circuitry and logic to enable contactless payment transactions. In this embodiment, a Near Field Communication (“NFC”) module 25 is provided to communicate data with an NFC capable payment token 12, such as an NFC payment card or NFC capable mobile device with integrated payment software and/or hardware as are known in the art. Components of the host computer 5 can also be in communication with a merchant system 13, which could be a merchant's Point of Sale (POS) back-end system or an online merchant's website server system, as well as merchant acquirer 14a, payment scheme 14b and card issuer 14c components over the data network 11, which are typically provided for authorizing and settling payment transactions with the merchant system 13, and need not be described further.

In the normal user operation, the user plugs the electronic device 3 into the host computer 5 to automatically load and launch application program code 26 stored on the electronic device 3. In an embodiment, the application program code 26 includes an application UI 30, that can be built in HTML5 for example, and a custom browser application 28 that is used to render the application UI 30 to the user on the host computer 5. Preferably, the browser application 28 is customized to restrict use for only the device application UI 30. The browser application 28 is coupled to the USB serial communication module 21 to make HTTP requests and receive responses via the electronic device 3 rather than directly using the host computer's network interface 5b.

### Electronic Device Architecture

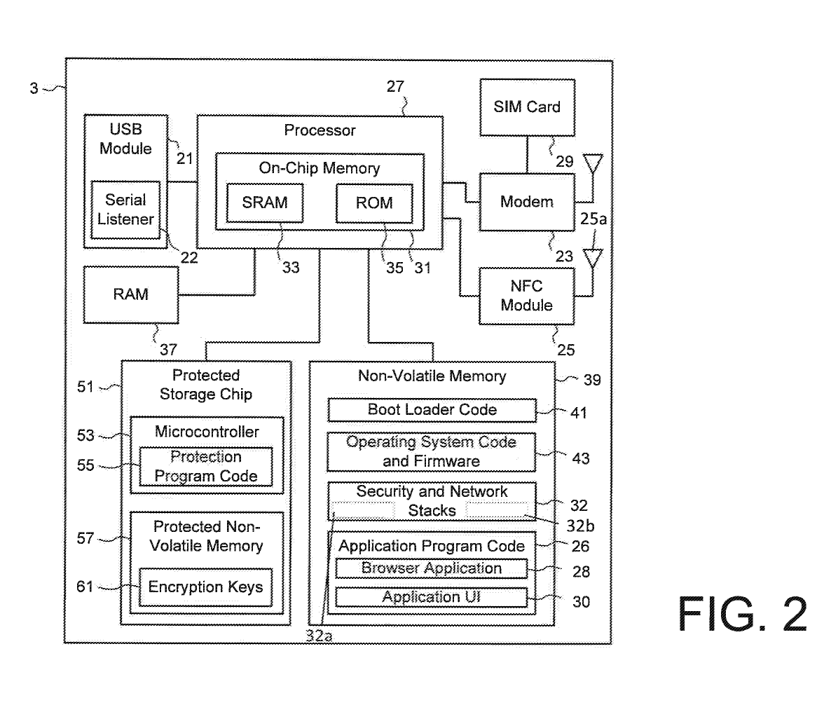

Referring to FIG. 2, an electronic device 3 according to an embodiment of the invention includes the USB serial communication module 21 and a modem 23, as discussed above, that are coupled to a processor 27. The electronic device 3 also includes a Subscriber Identity Module (SIM) 29 coupled to the modem 23, and an NFC module 25 and associated antenna 25a. The processor 27 may be any type of processor, including but not limited to a general-purpose digital signal processor or a special purpose processor. Optionally, the processor 27 may include an on-chip memory 31, for example, a Static Random Access Memory (“SRAM”) 33 and a Read Only Memory (“ROM”) 35. The processor 27 is also coupled for access to a volatile Random Access Memory (“RAM”) 37 and a non-volatile memory 39 of the electronic device 3, for example via a data bus (not shown).

The non-volatile memory 39 stores boot loader code 41 executing a boot loader program upon loading, an operating system (“OS”) code and firmware 43, a code for the security and network stacks 32, and a code for application programs 26, including the custom browser application 28 and the application UI 30. The processor 27 runs the boot loader code 41 upon power up of the electronic device 3, to load the OS code 45, the security and network stacks 32 and the application program code 26 into the RAM 37 for subsequent execution by the processor 27. The security and network stacks 32 include a cryptographic library that provides encryption and decryption functionality for data communicated to and from the electronic device 3.

The electronic device 3 is configured to route data traffic via the host computer 5, or via the onboard cellular data modem 23. The security stack 32a consists of all the components necessary to ensure secure access to the electronic device 3, including device authorization, user authentication and network traffic encryption. The USB serial communication module 21 integrates with the security stack 32a to apply the necessary encryption and headers to the requests it receives from the browser application 28. The network stack 32b consists of all the components necessary to make HTTP and HTTPS requests over the cellular data network 9 and the data network 11. The USB serial communication module 21 also integrates with the network stack 32b to submit the requests it receives from the browser application 28. Optionally, the electronic device 3 is configured with logic to perform routing of requests based on predetermined factors, such as signal strength, bandwidth speed, network data charges, etc. The electronic device 3 can determine connection availability and connection speed over the cellular data network 9 and if the cellular data signal is found to be weak or unavailable, the network stack may route the request via the network interface 5b of the host computer 5.

Preferably, the non-volatile memory 39 consists of one or more flash memory components, although other forms of non-volatile memory may be suitable. Optionally, the non-volatile memory 39 can be divided into logical storage partitions, a main partition storing current firmware and application program code and a backup partition storing a working copy of backup firmware and application program code. One or more further spare partitions may be provided for future applications.

Optionally, the electronic device 3 can include a protected storage chip 51 coupled to the processor 27, with a dedicated microcontroller (or microprocessor) 53 for executing a protection program code 55 that controls access to encryption key data 61 stored in the protected non-volatile memory 57 on the storage chip 51, as described in the Applicant's co-pending application entitled “Device and Method for Secure Memory Access”. The protection program code 55 controls access to the protected non-volatile memory 57 by making the stored encryption key data 61 available only during a pre-defined time window, within a pre-defined number of clock cycles once the electronic device 3 is powered on. The loading of the encryption key data 61 can be carried out as one of the initial steps in a boot loading (or bootstrapping) process and prior to initiating and accepting any external communications to the electronic device 3. The loaded encryption keys 61 are then available for subsequent use by the processor, when executing the OS code 43 and the application program code 45 to authenticate a user of the electronic device 3 and to handle service requests to and from the backend system 7. Such key based encryption and decryption techniques are of a type that are known to those skilled in the art of data cryptography and need not be described further. Thereafter, the processor 27 in the boot loader mode executes the remaining instructions to continue normal loading of the boot OS code and initialisation of the external communication interfaces, such as the USB serial communication module 21 and the modem 23.

Optionally, the electronic device 3 can be further adapted to include circuitry and logic to provide a defense against subversion of hardware attacks, such as voltage tampering, etc.

### Device and User Authentication Process

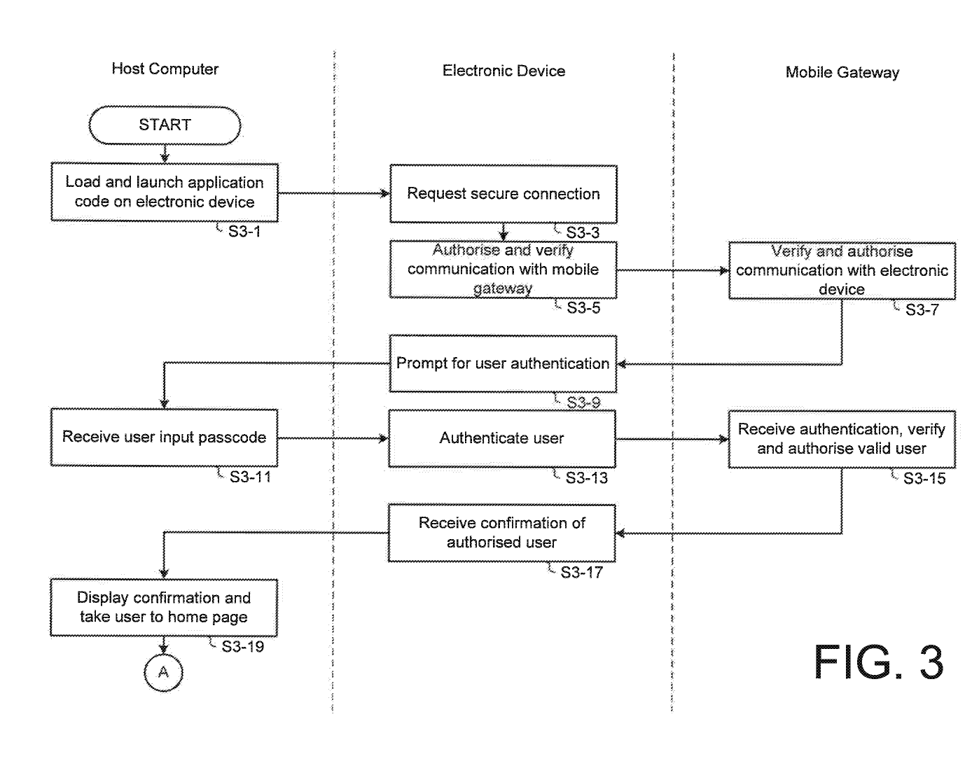

An exemplary embodiment of the process of device and user authentication using the electronic device 3 will now be described with reference to FIG. 3. At step S3-1, the user plugs the electronic device 3 into the host computer 5 to automatically load and launch the application program code 26 stored on the electronic device 3. The custom browser application 28 is launched and used to render and display the application UI 30 to the user in the host computer 5 environment. The user can interact with the application UI 30 being displayed in the browser 28, by clicking a link or a button to select one or more functions or services that requires communication with the mobile gateway 8 of the backend system 7. In response, the browser application 28 sends a data request to a serial communication handler (not illustrated) on the host computer 5, responsible for interfacing with the USB serial communication module 21 of the electronic device 3. The serial communication handler sends the data requests to a serial listener 22 of the USB serial communication module 21, via a USB serial driver installed on the host computer 5.

At step S3-3, the processor 27 of the electronic device 3 requests a secure connection to the mobile gateway 8 of the backend system 7 over the cellular data network 9, before user requests can be securely communicated with the backend system 7. Accordingly, at step S3-5, authentication and authorization of the electronic device 3 is processed, by authorizing and verifying communication with the mobile gateway 8. The requests are encrypted by the security stack 32a using the encryption keys 61 loaded into the SRAM 33 during the secure boot loading process described above.

The serial listener 22 of the USB serial communication module 21 sends the data request to the cryptography library of the security and network stacks 32, to encrypt the data request using the encryption keys 61. The serial listener 22 submits the request to the security and network stacks 32, which first checks if good cellular signal strength is available via the cellular data modem 23. If a strong cellular signal is detected, the data request is sent to the mobile gateway 8 over the cellular data network 9. Otherwise, the request can be submitted using the host computer 5 network interface 5b over the data network 11. It will be appreciated that this is one example of a possible data routing process by the electronic device 3, and in other examples, the routing decision can instead or additionally be based on other predetermined cellular network-related factors, such as bandwidth speed, network data charges, etc. If the request is sent over the cellular data network 9, the data request is converted into an encrypted HTTPS request using an Open SSL Library and passed to the cellular data modem 23, which transmits the request to the mobile gateway 8. On the other hand, if the request is sent using the host computer 5 network interface 5b, the serial listener 22 sends the request to the host computer 5 via the USB serial interface 5a. The HTTPS request is sent by the host computer 5 to the mobile gateway 8 over the data network 11 (e.g. the Internet) via the network interface 5b.

At step S3-7, the mobile gateway 8 authorizes and verifies communication with the electronic device 3, in a corresponding manner. The electronic device 3 processes authentication of the user after the electronic device 3 has been authenticated. At step S3-9, the electronic device 3 prompts the user for authentication. User authentication can take one or more of any known forms, for example, by prompting the user to input a pre-registered passcode via the application UI 30 and browser application 28, or via additional communication interfaces (not shown) that are made available on the electronic device, such as a thumbprint scanner, dials or buttons to select passcode digits, et. At step S3-11, the host computer 5 receives user input of a passcode via the application UI 30. The user input passcode is verified by the electronic device 3 against a stored pre-registered passcode in order to authenticate the user at step S3-13. At step S3-15, authentication of the user is securely communicated to the mobile gateway 8, which verifies that the user is valid by comparing received details with stored records for the user.

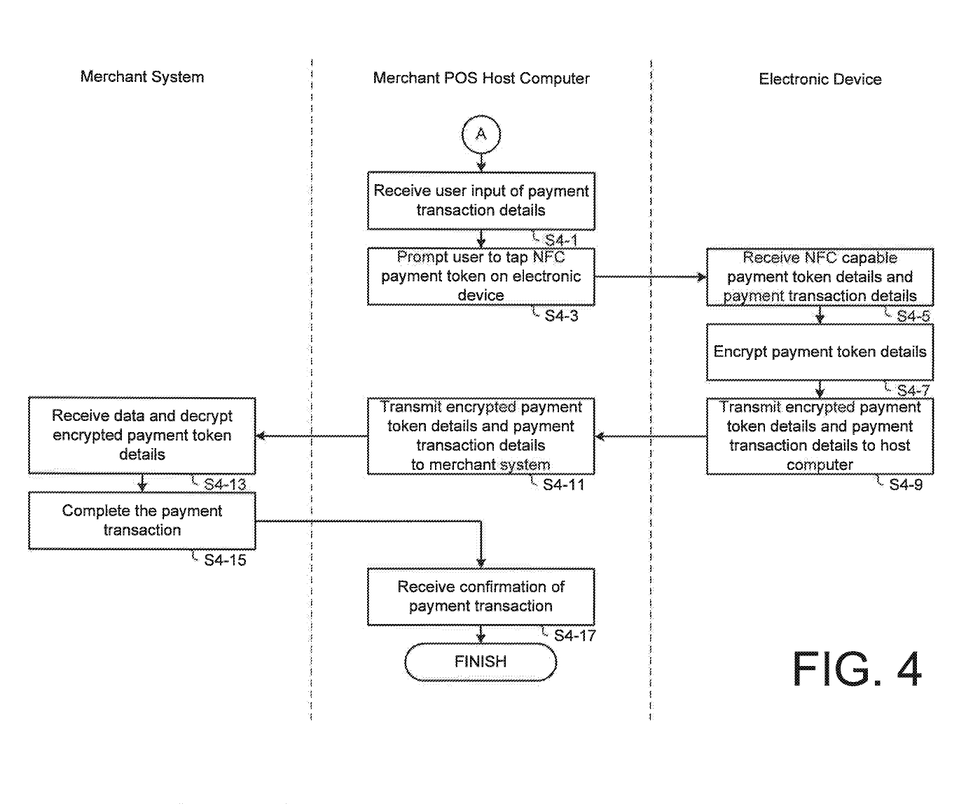

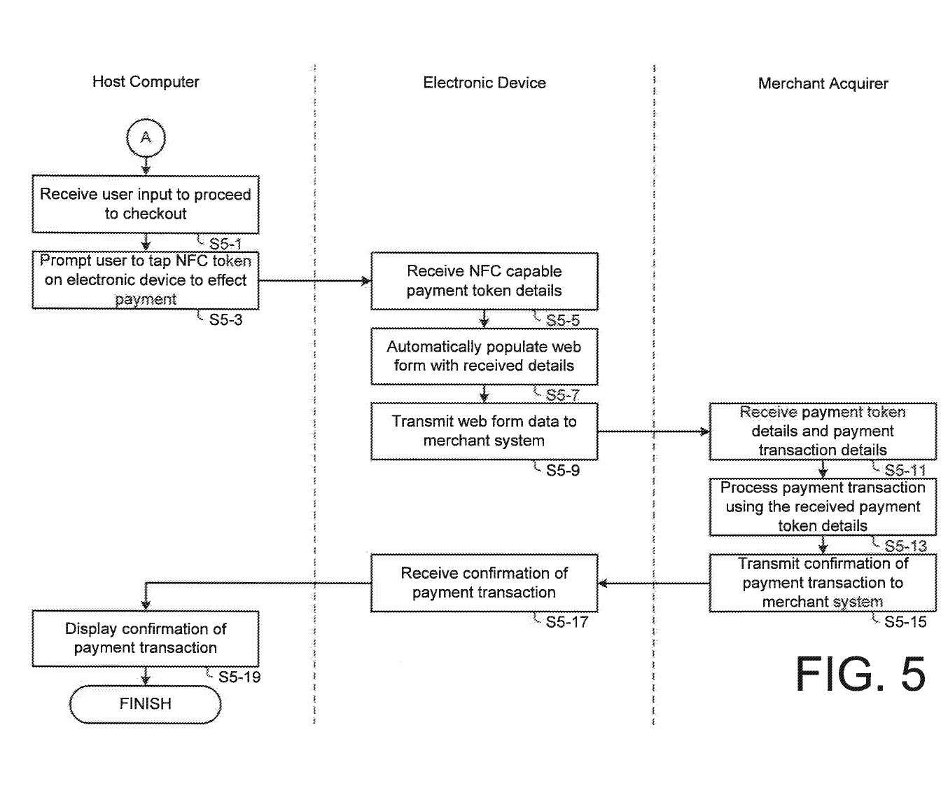

At step S3-17, the electronic device 3 receives confirmation from the mobile gateway 8 that the user is authorized. In response to confirmation that both the electronic device 3 and the user are authenticated and authorized, the browser application 28 and the application UI 30 display confirmation to the user and proceed with normal user operation at step S3-19, by displaying to the user a secure web home page for the services provided by a backend system 7. In an alternative embodiment, the user can proceed to input an address of an online merchant system 13, e.g. a Uniform Resource Locator (“URL”), for secure online shopping via the authenticated communication link between the electronic device 3 and the mobile gateway 8, as will be described below with reference to FIG. 4. In yet a further alternative embodiment, the user is a merchant at a POS, and the authenticated user can proceed to process a payment transaction using a customer's NFC capable payment token via the authenticated electronic device 3, as will be described below with reference to FIG. 5.

### Merchant Point of Sale Embodiment

An embodiment of a process of secure contactless payment transactions using the electronic device 3 will now be described with reference to FIG. 4, to illustrate the technical advantage of the secure computing environment described above. In this embodiment, the host computer 5 is a merchant POS host computer.

Referring to FIG. 4, the contactless payment process continues from step S3-19 above, where the application UI 30 of the browser application 28 on the host computer 5 prompts the user for payment transaction details. At step S4-1, the host computer 5 receives user input of the payment transaction details, such as the cost of an item or service to be purchased and/or an identifier of the item or service. The user input can be received via one or more conventional input devices, such as a keyboard, key pad, barcode scanner, etc. At step S4-3, the host computer 5 prompts the user to tap an NFC capable payment token 12 on the electronic device 3 to initiate the payment transaction. At step S4-5, the electronic device 3 receives payment token details from the NFC capable payment token 12 via the integrated NFC module 25 of the electronic device 3.

At step S4-7, the electronic device 3 encrypts the received payment token details, using the encryption keys 61 loaded from the protected storage chip 51. The electronic device 3 transmits the encrypted payment token details and the payment transaction details to the host computer 5 at step S4-9, over the USB connection via the USB serial communication module 21. After receiving the data, the host computer 5 in turn transmits the encrypted payment token details and the payment transaction details to the merchant system 13 at step S4-11. In this embodiment, the host computer 5 communicates with the merchant system 13 over the data network 11 via a network interface 5b. Preferably, the host computer 5 establishes a secure connection over the data network 11, such as an HTTPS connection, for an additional layer of data security. Alternatively, the electronic device 3 can be configured to transmit the encrypted payment token details and the payment transaction details to the merchant system 13 over the secured communication link to the mobile gateway 8 via the cellular data network 9, and a subsequent link between the backend system 7 and the merchant system 13 via the data network 11.

The merchant system 13 receives and decrypts the encrypted payment token details at step S4-13, before processing the payment transaction identified by the received payment transaction details, using the decrypted payment token details. It will be appreciated that shared symmetric keys or asymmetric keys 61 can be used by the merchant system 13 and the electronic device 3, as are well known in the art. As an alternative, the merchant POS host computer 5 may include all of the merchant back-end system components to process the payment transaction via the merchant acquirer 14a, the payment scheme 14b and the card issuer 14c. In this alternative arrangement, the host computer 5 can instead communicate the encrypted payment token details and the payment transaction details to the merchant acquirer 14a to decrypt and process as described above. At step S4-17, the host computer 5 receives confirmation from the merchant system 13 via the data network 11 that the payment transaction is complete, and can display the confirmation to the merchant.

In this way, a secure connection between the portable electronic device 3 and the host computer 5 is established for the transmission of the encrypted payment token details to the merchant system 13 via the host computer 5. Improved security is provided because the application program code 26 running directly on the portable electronic device 3 is effectively isolated from the host computer 5 and it is not possible for malicious software or the like on the host computer 5 to access or alter data stored and processed by the electronic device 3, such as the payment token details used in the payment transaction. Moreover, both the user and the electronic device 3 are verified and authenticated via a secure connection to the mobile gateway 8 over the cellular data network 9, again shielding the authentication process from potentially malicious software or hardware installed on the host computer 5.

### Online Payment Embodiment

An embodiment of a process of secure online payment transactions using the electronic device 3 will now be described with reference to FIG. 5, to further illustrate the technical advantage of the secure computing environment described above. In this embodiment, the host computer 5 is a customer's host computer displaying the application UI 30 of the application program code 26 running on the portable electronic device 3 and the merchant system 13 includes a web server component (not shown) for hosting an online merchant website. It will be appreciated that the web server component could be provided as a separate component in communication with the merchant system 13 over the data network 11.

Referring to FIG. 5, the contactless payment process continues from step S3-19 above, where the application UI 30 of the browser application 28 on the host computer 5 processes user input relating to an online request requiring a payment transaction to complete the request, to purchase or place an order for a product or service offered by the merchant via the online merchant website. At step S5-1, the host computer 5 receives user input indicating that the customer is ready to proceed with the payment transaction. The user can be prompted to press a checkout button displayed on an online shopping website, as is well known in the art. In response to receiving user input to proceed with the payment transaction, the host computer 5 displays a checkout web form and prompts for the user to tap an NFC capable payment token 12 on the electronic device 3 to initiate the payment transaction. Preferably, details associated with the online payment transaction, such as a merchant or purchase reference number and a transaction amount, are automatically read by the electronic device 3 and used to configure the checkout web form data. Optionally, the electronic device 3 can be configured to retrieve the payment token details from the NFC payment token 12 via the NFC module 25 prior to the payment transaction process, and to securely store the retrieved payment token details, in encrypted form in a non-volatile memory 39 or in the protected storage chip 51. The stored payment token details can then be retrieved to populate the checkout web form without further user interaction.

At step S5-5, the electronic device 3 receives payment token details from the NFC capable payment token 12 via the integrated NFC module 25 of the electronic device 3. In this exemplary embodiment, the electronic device 3 automatically populates the checkout web form with the received payment token details. Optionally, the electronic device 3 retrieves customer details associated with the received payment token details, such as a postal address for the registered customer, from the secure memory or a remote database, and automatically includes the retrieved customer details in the checkout web form data. At step S5-9, the checkout web form data is transmitted to the merchant acquirer 14a via the secure and authenticated connection established between the electronic device 3 and the mobile gateway 8 over the cellular data network 9.

At step S5-11, the merchant acquirer 14a receives the payment token details and payment transaction details, and processes the payment transaction identified by the received payment transaction details, using the received payment token details at step S5-13. Typically, the merchant acquirer 14a processes the payment transaction via the payment scheme 14b and the card issuer 14c to send the payment to the merchant's financial account. Once the merchant acquirer 14a confirms that payment for the transaction has been made, at step S5-15 the merchant acquirer 14a transmits confirmation of the payment transaction to the merchant system 13, and in turn it is received by the electronic device 3 at step S5-17. At step S5-19, the confirmation is displayed to the user by the host computer 5, via the application UI 30 displayed by the browser 28 running on the electronic device 3.

In this way, a secure connection between the portable electronic device 3 and the merchant acquirer 14a is established for the transmission of the data to process the online payment transaction via the authenticated mobile gateway 8, whereby the merchant system 13 does not receive the customer's payment token details. Moreover, as with the embodiment described above, improved security is provided by isolating data communication and processing by application program code 26 running directly on the portable electronic device 3 from the host computer 5, so that the host computer 5 is not able to access or alter the payment token details used in the payment transaction, nor are the payment token details transmitted over the potentially unsecured communication channel via the network interface 5b of the host computer 5.

### Alternative Embodiments

It will be understood that embodiments of the present invention are described herein by way of example only, and that various changes and modifications may be made without departing from the scope of the invention.

For example, in the embodiments described above, the portable electronic device is a USB flash memory storage device. It will be appreciated that the portable electronic device may be any device that is portable and used to store digital information. Additionally, the data communication interface between the portable device and a host computing device or platform may be any form of standard or proprietary computing interface, such as IEEE 1394 (Firewire), SCSI, Thunderbolt, Lightning, etc.

In the embodiments described above, the electronic device is powered by the host computer via the USB interfaces when connected. Optionally, the electronic device can include a battery and associated power charging circuitry, for powering the components of the device and enabling persistent storage of data in volatile memory if necessary.

In the embodiments described above, the cellular data network 9 and the data network 11 are illustrated as separate networks. It will be appreciated that the data network itself can include communication links or paths over a cellular communication network such as GPRS, EDGE, 3G, 4G, LTE, for example, or a combination of such communication paths.

The encryption keys and passcodes described above may take any respective form, and may be composed of numeric or alphabetic symbols, non-alphanumeric symbols, or a combination of such symbols.

Various software implementations are described in terms of the exemplary electronic device. After reading this description, it will become apparent to a person skilled in the art how to implement the invention using other computer systems and/or computer architectures.

The computer programs (also called computer control logic) discussed in the embodiments above, when executed, enable the computer system of the electronic device to implement embodiments of the present invention as discussed herein. Accordingly, such computer programs represent controllers of the computer system. Where the embodiment is implemented using software, the software may be stored in a computer program product and loaded into the computer system using a removable storage drive, a hard disk drive, or a communication interface. The terms “computer program medium” and “computer usable medium” are used generally to refer to media such as a removable storage drive, or a hard disk installed in hard disk drive. These computer program products are means for providing software to computer system of the electronic device. However, these terms may also include signals (such as electrical, optical or electromagnetic signals) that embody the computer program disclosed herein.

Alternative embodiments may be implemented as control logic in hardware, firmware, or software or any combination thereof.

What is claimed is:

1. A portable electronic device comprising:
a. a memory storing an application software for initiating a payment transaction with a remote system;
b. a data interface for coupling the portable electronic device to a host computer;
c. a contactless interface for receiving payment token data from a contactless payment token; and
d. a mobile network interface for communication of data over a cellular network;
wherein the application software is executed from the portable electronic device when the portable electronic device is connected to the host computer and configures the portable electronic device to initiate a payment transaction by receiving the payment token data via the contactless interface and transmitting the payment token data to the remote system via the mobile network interface.

2. The device of claim 1, wherein the application software further configures the portable electronic device to establish a secure connection with a remote mobile gateway over the cellular network.

3. The device of claim 2, wherein the secure connection with the remote mobile gateway over the cellular network is established by authorizing and verifying communication between the portable electronic device and the mobile gateway, and authenticating and validating a registered user of the portable electronic device.

4. The device of claim 1, wherein the application software further configures the portable electronic device to encrypt the payment token data, and to transmit encrypted payment token data to the remote system.

5. The device of claim 4, wherein the payment token data is encrypted using an encryption key stored in a protected non-volatile memory of the portable electronic device.

6. The device of claim 5, wherein the application software is configured to transmit the encrypted payment token data to the remote system via the host computer instead of the mobile network interface.

7. The device of claim 1, wherein the data interface comprises a Universal Serial Bus (USB) data interface.

8. The device of claim 1, wherein the memory comprises a non-volatile flash memory.

9. The device of claim 1, wherein the contactless payment token is a Near Field Communication (NFC) capable payment card or a mobile device.

10. The device of claim 1, wherein the application software for initiating the payment transaction is operable to transmit data defining an application user interface for display by the host computer and to receive data defining user input via the application user interface from the host computer via the data interface.

11. The device of claim 10, wherein: the application software comprises a web browser, the application user interface includes a web form for initiating the payment transaction, and the application software further configures the portable electronic device to automatically populate the web form with the received payment token data.

12. The device of claim 1, further comprising a means for determining that data is to be communicated via the data interface based on cellular network connection availability or connection speed.

13. A computer-implemented method for secure transaction processing in a portable electronic device including a memory storing application software executable from the portable electronic device, a data interface for coupling the portable electronic device to a host computer, a contactless interface for receiving payment token data from a contactless payment token, and a mobile network interface for communication of data over a cellular network, the method comprising the steps of:
a. executing the stored application software from the portable electronic device when the portable electronic device is connected to the host computer to initiate a payment transaction with a remote system;
b. receiving the payment token data via the contactless interface; and
c. transmitting the payment token data to the remote system via the mobile network interface.
